(19) United States
(12) Patent Application Publication
(10) Pub. No.: US 2008/0126064 A1
(43) Pub. Date: May 29, 2008

(54) METHOD FOR SIMULATING CIRCUIT RELIABILITY AND SYSTEM THEREOF

(75) Inventors: Huai-Yuan Tseng, Taoyuan County (TW); Chen-Pang Kung, Taoyuan County (TW); Ko-Yu Chiang, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/611,150

(22) Filed: Dec. 15, 2006

(30) Foreign Application Priority Data
Aug. 9, 2006 (TW) 95129185

(51) Int. Cl. G06F 17/50

(52) U.S. Cl. 703/14

(57) ABSTRACT

A method and a system for simulating circuit reliability are provided. The method and the system calculate a variation of a device parameter of a thin-film transistor after the thin-film transistor has been operated for a period of time. Then, according to the variation, the method and the system calculate an operation timing waveform to add a circuit reliability analysis to the circuit simulation. Therefore, the invention is able to estimate the operation of the circuit more realistically.

### CROSS-REFERENCE TO RELATED APPLICATION

This application claims the priority benefit of Taiwan application serial no. 95129185, filed Aug. 9, 2006. All disclosure of the Taiwan application is incorporated herein by reference.

### BACKGROUND OF THE INVENTION

1. Field of the Invention

The present invention relates to a method for simulating circuit reliability and system thereof, and more particularly, to a reliability simulation method and system thereof that simulate a variation of a device parameter of a thin-film transistor (TFT).

2. Description of Related Art

In a liquid crystal display, each sub-pixel of an active matrix liquid crystal display needs a thin-film transistor (TFT) to serve as a switch for accurately controlling the gray scale of each pixel. Thus, active matrix liquid crystal displays are widely adopted in large-area and high-resolution displays. Consequently, the thin-film transistor liquid crystal display (TFT-LCD) is a mainstream product in the display market, and is extensively used in notebook computers, digital cameras and high picture quality televisions.

At present, an increasing number of manufacturers invest their money on the research and development of thin-film transistor liquid crystal displays. In the process of developing TFT-LCD, a device model and a simulation platform of the thin-film transistor are often utilized to simulate and find the operation timing waveform and the operation current of the circuit. However, the existing device model and simulation platform do not provide a reliability analysis. In other words, after the circuit has been operated for a period of time, due to the effects of driving voltage, conducting current and operating temperature on the thin-film transistor, the device parameters (for example, the threshold voltage and the leakage current) may change. Hence, the operation of the circuit or the imaging quality of the display is likely to be affected.

For example, after a display has been used for a period of time, due to the bias of the thin-film transistor in an integrated driving circuit, the threshold voltage of the thin-film transistor will change and the drain current of the thin-film transistor will drift. As a result, the thin-film transistor will have insufficient driving power so that the driving circuit may fail and the display may produce erroneous images.

In brief, if a reliability analysis of a circuit is not included in the R&D process, the characteristics of the devices will change after a period of time of operation so that circuit operation is likely to change with time. Furthermore, a number of unpredictable problems related to the quality of the product may appear in the future.

U.S. Pat. No. 5,615,377, U.S. Pat. No. 6,541,285 and U.S. Pat. No. 6,020,753 disclose methods of simulating the reliability of hot carriers in complementary metal-oxide-semiconductor (CMOS) devices. The methods in the foregoing patents deduce an age parameter through measuring the substrate current of a CMOS device, thereby obtaining a lifetime for the device. However, the foregoing U.S. patents are limited to the reliability analysis of CMOS devices. So, in circuit simulation the analysis of reliability of other devices (for example, a thin-film transistor) are not provided.

### SUMMARY OF THE INVENTION

Accordingly, at least one objective of the present invention is to provide a method for simulating circuit reliability by calculating the variation of the device parameter of a thin-film transistor and changing the device parameter or the circuit structure of the thin-film transistor in the circuit so as to add a circuit reliability analysis.

At least another objective of the present invention is to provide a method for simulating circuit reliability by using a circuit simulation module with a time-varying parameter to calculate an operation timing waveform of the circuit and determine the circuit reliability.

At least another objective of the present invention is to provide a system for simulating circuit reliability such that the device parameter or the circuit structure of a thin-film transistor in a circuit is changed through a reliability simulation module in order to add a circuit reliability analysis.

To achieve these and other advantages and in accordance with the purpose of the invention, as embodied and broadly described herein, the invention provides a method for simulating circuit reliability. The foregoing circuit comprises a plurality of circuit devices and the circuit devices include at least a thin-film transistor. First, the device parameter and a circuit structure of a portion of the foregoing circuit devices are input. Then, according to a reliability model parameter and a reliability influence parameter, a reliability simulation module is used to calculate a variation of the device parameter of the foregoing thin-film transistor. Next, according to the variation, the device parameters and the circuit structure of the thin-film transistor are changed. Finally, through a circuit simulation module, an operation timing waveform of the foregoing circuit is calculated.

The present invention also provides another method for simulating circuit reliability. The foregoing circuit includes a plurality of thin-film transistors. The circuit devices include at least one thin-film transistor. First, the device parameter and a circuit structure of a portion of the foregoing circuit devices are input. Then, a time-varying parameter circuit simulation module is provided. The time-varying parameter circuit simulation module is used to calculate an operation timing waveform of the foregoing circuit.

The present invention also provides a system for simulating circuit reliability. The foregoing circuit includes a plurality of circuit devices. The circuit devices include at least one thin-film transistor. The simulation system includes a circuit netlist, device model parameter data, a circuit simulation module and a reliability simulation module. The circuit netlist is used to describe the circuit structure of the foregoing circuit. The device model parameter data is used to describe a device parameter of each of the circuit devices. The circuit simulation module is used to calculate an operation timing waveform of the foregoing circuit according to the circuit structure and the device parameters. The reliability simulation module is used to calculate the variation of the device parameter of the foregoing thin-film transistor according to reliability model parameters and reliability influence parameters. According to the variation, the reliability simulation system changes the device parameter or the circuit structure of the foregoing thin-film transistor. Then, through the circuit simulation module, the operation timing waveform of the foregoing circuit is re-calculated.

In the present invention, by calculating the variation of the device parameter of the thin-film transistor, a reliability analysis of the circuit is added to the circuit simulation so that the circuit designer can simulate the operation of the circuit more realistically.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow diagram showing the steps for simulating circuit reliability according to one embodiment of the present invention.

FIG. 2 is a circuit diagram according to one embodiment of the present invention.

FIG. 3 is a timing waveform of a circuit output signal according to one embodiment of the present invention.

FIG. 4 is a flow diagram showing the steps for simulating circuit reliability according to another embodiment of the present invention.

FIG. 5 is a circuit diagram showing an added equivalent circuit device according to one embodiment of the present invention.

FIG. 6 is a flow diagram showing the steps for simulating circuit reliability according to another embodiment of the present invention.

FIG. 7 shows a system for simulating circuit reliability according to one embodiment of the present invention.

FIG. 8 shows another system for simulating circuit reliability according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

At present, the numerical simulation of the voltage and current at various nodes in a circuit has become so common that a general-purpose circuit simulation program, for example, SPICE (Simulation Program with Integrated Circuit Emphasis) has been developed. However, the simulation program does no include the device reliability analysis. Therefore, the embodiments of the present invention provide a method for simulating circuit reliability. The method also takes into consideration of changes in the operation waveform of the circuit resulting from any changes in device characteristics after being operated for a period of time. In the following, a few embodiments are provided to describe the present invention and a thin-film transistor is used to show the changes in device characteristics. However, this should by no means limit the scope of the present invention.

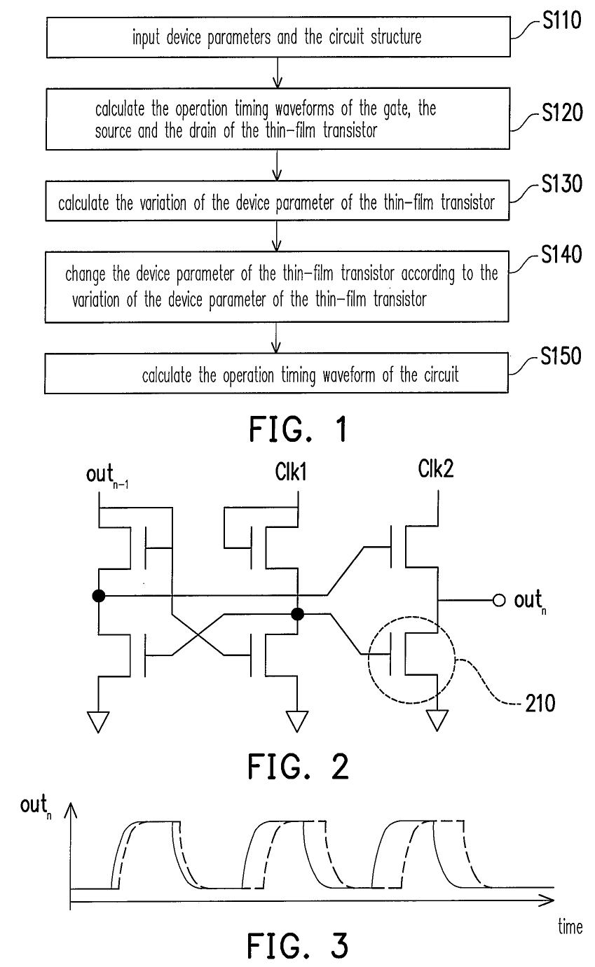

FIG. 1 is a flow diagram showing the steps for simulating circuit reliability according to one embodiment of the present invention. In the present embodiment, the simulated circuit includes, for example, a plurality of circuit devices. The circuit devices include at least one thin-film transistor. The thin-film transistor is an amorphous silicon thin-film transistor or other type of thin-film transistor, for example. Here, assume the simulated circuit is as shown in FIG. 2. The circuit in FIG. 2 has a thin-film transistor 210.

First, as shown in FIG. 1, the device parameter and the circuit structure of a portion of the circuit devices are input (step S110). In the present embodiment, the device parameters include, for example, threshold voltage, leakage current and drain current of the transistor. Alternatively, the model numbers of the circuit devices are directly input in step S110. The circuit structure input in step S110 includes the connecting relationships between the circuit devices and the input signal timing waveforms in the circuit (for example, the timing waveforms Outₙ₋₁, Clk1 and Clk2 in FIG. 2).

Then, through a circuit simulation module, an operation timing waveform of the gate, the source and the drain of the thin-film transistor are calculated (step S120). In the present embodiment, the circuit simulation module is a SPICE circuit simulation program, for example. The SPICE circuit simulation program uses the device parameters and the circuit structure which are already input to calculate the voltage and current at various nodes in the circuit. In step S120, the operation timing waveforms at the three terminals (the gate, the source and the drain) of the thin-film transistor 210 in the circuit are captured and the duty cycles of the bias on the three terminals are calculated.

After calculating the operation timing waveforms of the three terminals of the thin-film transistor, a reliability simulation module is used to calculate the variation of the device parameter of the thin-film transistor according to reliability model parameters and reliability influence parameters (step S130). The reliability influence parameters are the factors that cause a change in the device parameter of the thin-film transistor and include, for example, operating temperature, time, voltage, conducting current, humidity, pressure and lighting condition of the thin-film transistor.

In the present embodiment, assume the variation of the device parameter of the thin-film transistor 210 in FIG. 2 is taken into consideration. Moreover, the device parameter of the thin-film transistor 210 are influenced by the operating time, the operating temperature and the voltages applied to the three terminals of the thin-film transistor 210. Furthermore, the threshold voltage of the thin-film transistor 210 is used as an example and a predetermined formula is used to calculate the variation in threshold voltage. The formula is, for example,

$$Δ {V}_{T} = {( {V}_{G +} - {V}_{T 0} )}^{α +} \cdot \{ 1 - exp [ - {( \frac{t \cdot Dc}{{τ}_{+}} )}^{β +} ] \} \cdot {f}^{+} ( {V}_{D} ) - {( {V}_{G -} + {V}_{T 0} )}^{α -} \cdot \{ 1 - exp [ - {( \frac{t \cdot ( 1 - Dc )}{{τ}_{-}} )}^{β -} ] \} \cdot f ( {t}_{ON} ) \cdot {f}^{-} ( {V}_{D} ) \\ In formula ( 1 ) , f ( {t}_{ON} ) = 1 - \frac{{τ}_{R C}}{{t}_{ON}} + \frac{{τ}_{R C}}{{t}_{ON}} exp ( - \frac{{t}_{ON}}{{τ}_{RC}} ) , {τ}_{RC} = {R}_{Si} {C}_{Si} , \\ {τ}_{+} = {τ}_{0 +} exp ( \frac{{E}_{τ +}}{kT} ) , {τ}_{-} = {τ}_{0 -} exp ( \frac{{E}_{τ -}}{kT} ) , \\ {f}^{+} ( {V}_{D} ) = \frac{2}{3} \cdot \frac{\begin{matrix}{( {V}_{G +} - {V}_{T 0} )}^{3} - \\ {( {V}_{G +} - {V}_{D} - {V}_{T 0} )}^{3}\end{matrix}}{\begin{matrix}{( {V}_{G +} - {V}_{T 0} )}^{2} - \\ {( {V}_{G +} - {V}_{D} - {V}_{T 0} )}^{2}\end{matrix}} \cdot {( {V}_{G +} - {V}_{T 0} )}^{- 1} , \\ {f}^{-} ( {V}_{D} ) = 1 + \frac{{L}^{2} + 2 \cdot {L}_{O}}{2 L \cdot ( L + 2 \cdot {L}_{O} ) ( {V}_{T 0} - {V}_{G -} )} \cdot {V}_{D} \qquad ( 1 )$$

wherein, V_{G+} and V_{G-} represent the positive and negative biases of the gate of the thin-film transistor, V_{T0} represents the native threshold voltage of the thin-film transistor, t represents the bias period of the thin-film transistor, Dc represents the duty cycle of the voltage V_{G+}, T₊ and T₋ represent the temperature effect of positive and negative biases, T represents the operating temperature of the thin-film transistor, R_{Si} is the resistance of the thin-film transistor, C_{Si} is the capacitance of the insulator, V_{D} is the bias at the drain of the thin-film transistor, t_{ON} is the pulse width when V_{G+} is at a high voltage level, L is the channel length of the thin-film transistor, L_{O} is the overlap length between the gate and the source/drain of the thin-film transistor.

In the foregoing formula, α^{±},β^{±},T_{±},E_{T±} are eight reliability simulation parameters and the reliability simulation parameters are obtained, for example, by actually measuring the changes of the device parameter, such as the threshold voltage and the leakage current of the thin-film transistor, with time. Then, a numerical analysis is performed to fit the foregoing formula in order to get the reliability model parameters.

Next, according to the variation of the device parameter of the thin-film transistor, the device parameter of the thin-film transistor is changed (step S140). In the present embodiment, because of the influence of operating time, voltage and temperature on the thin-film transistor, the device parameter of the thin-film transistor originally input in step S110 has already changed. Therefore, in step S140, the device parameter of the thin-film transistor is re-entered (or modifying the device parameter of the thin-film transistor in step S110). Since the variation of the threshold voltage in the thin-film transistor 210 has already been calculated in step S110, the threshold voltage of the thin-film transistor 210 is modified in step S140.

Finally, through the circuit simulation module, the operation timing waveform of the simulated circuit is calculated (step S150). In the present embodiment, the circuit simulation module is a SPICE circuit simulation program, for example. The SPICE circuit simulation program uses the changed the device parameter of the thin-film transistor and the originally input circuit structure to re-calculate the voltage and current of various nodes in the circuit. Here, for example, the output signal Outₙ at the output terminal of the circuit in FIG. 2 is shown in FIG. 3. In FIG. 3, the horizontal coordinate is time and the vertical coordinate is the voltage of the output signal Outₙ. The solid line shows the timing waveform of the output signal Outₙ calculated by the SPICE circuit simulation program initially. The dash line shows the timing waveform of the output signal Outₙ calculated by the SPICE circuit simulation program after calculating the variations of the device parameter of the thin-film transistor.

After calculating the operation timing waveform in step S150, the errors in the current and voltage when the circuit is used for a period can be found. Hence, whether the simulated circuit is able to operate normally after being operated for a period of time or not can be determined.

In the following, another embodiment is described to explain the method for simulating circuit reliability so that anyone familiar with the techniques in this area can easily apply the present invention.

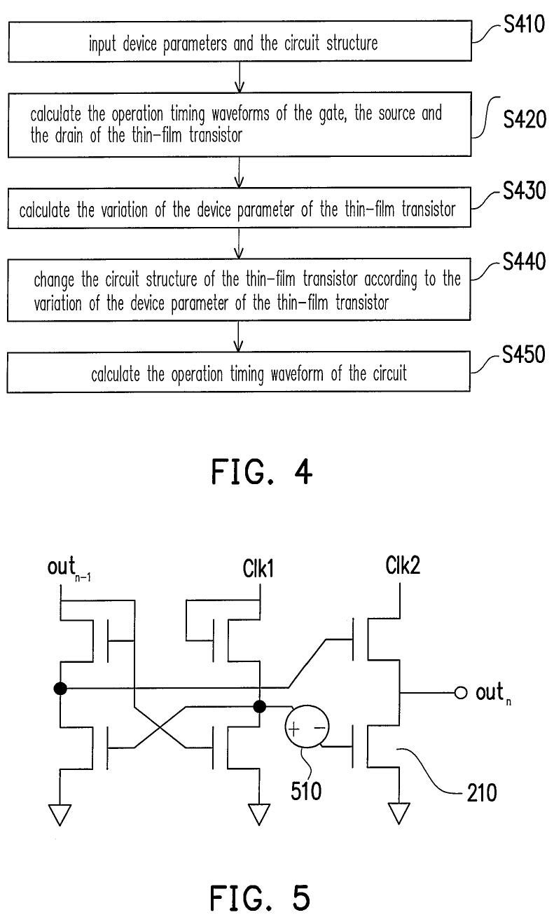

FIG. 4 is a flow diagram showing the steps for simulating circuit reliability according to another embodiment of the present invention. In the present embodiment, the simulated circuit includes a plurality of circuit devices, for example. The circuit devices include at least one thin-film transistor. The thin-film transistor is an amorphous silicon thin-film transistor or other type of thin-film transistor, for example. Here, assume the simulated circuit is the one shown in FIG. 2 with the thin-film transistor 210.

First, as shown in FIG. 4, the device parameter and the circuit structure of a portion of the circuit devices are input (step S410). Then, through a circuit simulation module, operation timing waveforms of the gate, the source and the drain of the thin-film transistor are calculated (step S420). According to reliability model parameters and reliability influence parameters, a reliability simulation module is used to calculate the variation of the device parameter of the thin-film transistor (step S430). Since the steps S410˜S430 are identical to the steps S110˜S130 in FIG. 1, a detailed description is not repeated.

Next, according to the variation of the device parameter of the thin-film transistor, the circuit structure of the thin-film transistor is changed (step S440). In the present embodiment, the method of changing the circuit structure of the thin-film transistor includes, for example, adding an equivalent circuit device to a pre-simulated circuit such that the equivalent circuit device is equivalent to the variation of the device parameter of the thin-film transistor. The equivalent circuit device includes an equivalent voltage source, an equivalent resistor, an equivalent current source or an equivalent capacitor. Here, if the threshold voltage calculated in step S430 is found to increase, then the gate of the original thin-film transistor 210 is coupled to an equivalent voltage source 510 as shown in FIG. 5 to equate with the increase in the threshold voltage of the thin-film transistor 210 in step S440. Furthermore, in step S440, the circuit structure of the thin-film transistor 210 is re-entered (or the input circuit structure in step S410 is modified).

Finally, through the circuit simulation module, the operation timing waveform of the simulated circuit is calculated (step S450). Since the step S450 is identical to the step S 150 in FIG. 1, a detailed description is not repeated.

However, anyone knowledgeable in this area may notice that, if the foregoing embodiments are simultaneously used, the variation of the device parameter of the thin-film transistor are calculated, then either the device parameter or the circuit structure of the thin-film transistor is selected for change according to the variation.

From the foregoing embodiments, one may observe that a reliability analysis of the thin-film transistor is added to the native circuit simulation so that whether the simulated circuit is able to operate normally after being operated for a period can be determined. In the following, an embodiment is provided to illustrate the method for simulating circuit reliability so that anyone familiar with the techniques in this area can easily apply the present invention.

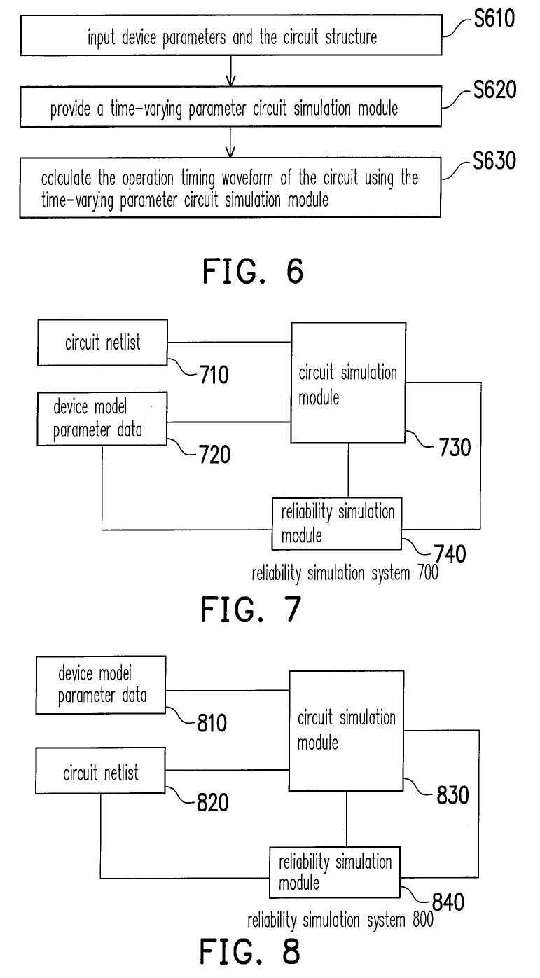

FIG. 6 is a flow diagram showing the steps for simulating circuit reliability according to another embodiment of the present invention. As shown in FIG. 6, the simulated circuit in the present embodiment includes a plurality of circuit devices, for example. The circuit devices include at least one thin-film transistor. The thin-film transistor is an amorphous silicon thin-film transistor or other type of thin-film transistor, for example.

First, as shown in FIG. 6, the device parameter and the circuit structure of a portion of the circuit devices are input (step S610). In the present embodiment, the device parameter of the thin-film transistor includes threshold voltage, leakage current and drain current of the transistor, for example. Alternatively, in step S610, the model numbers of the circuit devices are directly input. The circuit structure to be input in step S610 includes the connecting relationships between the circuit devices.

Next, a time-varying parameter circuit simulation module is provided (step S620). In the present embodiment, the time-varying parameter circuit simulation module is used to calculate the operation timing waveform of the circuit. Furthermore, the time-varying parameter circuit simulation module includes a time-varying thin-film transistor parameter model. The model is able to calculate the variation of the device parameter of the thin-film transistor. The factors that change the device parameter of the thin-film transistor include operating temperature, operating time and the operation timing waveform.

Finally, the time-varying circuit simulation module is used to calculate the operation timing waveform of the simulated circuit (step S630). In step S630, the variation of the device parameter of the thin-film transistor that directly lead to a change of the operation timing waveform of the circuit have been calculated. In other words, the operation timing waveform calculated in step S630 has already included a reliability analysis of the thin-film transistor so that whether the circuit is able to operate normally after being operated for a period can be determined.

Although the three foregoing embodiments have already described a possible state for simulating circuit reliability, anyone familiar with the techniques in this art knows that the design of the circuit simulation programs is different between manufacturers. Therefore, the applications of the present invention are not limited to that possible state. In other words, any circuit simulation that involves simulating the variation of the device parameter of circuit devices and using the variation to simulate the operation of the circuit should be regarded as fitting the spirit of the present invention. In the following, a few embodiments of systems are provided so that anyone familiar with the techniques in this area can easily apply the present invention.

FIG. 7 shows a system for simulating circuit reliability according to one embodiment of the present invention. The system is used to simulate a circuit and estimate the operation timing waveform of the circuit. The circuit includes a plurality of circuit devices. The circuit devices include at least one thin-film transistor or other type of thin-film transistor.

As shown in FIG. 7, the reliability simulation system 700 includes a netlist 710, device model parameter data 720, a circuit simulation module 730 and a reliability simulation module 740. In FIG. 7, the circuit netlist 710 describes the circuit structure of the circuit. The device model parameter data 720 describes device parameters of the circuit devices in the circuit. In the present embodiment, the device parameter of the thin-film transistor are, for example, threshold voltage, leakage current and drain current of the transistor. The circuit structure includes the connecting relationships between the circuit devices, for example.

According to the circuit structure described in the circuit netlist 710 and the device parameters described in the device model parameter data 720, the circuit simulation module 730 calculates the operation timing waveform of the circuit. The reliability simulation module 740 calculates the variation of the device parameter of the thin-film transistor according to reliability model parameters and reliability influence parameters. The reliability influence parameters are factors that cause a change in the device parameter of the thin-film transistor, and the reliability influence parameters includes, for example, operating temperature, time, voltage, conducting current, humidity, pressure and lighting condition of the thin-film transistor. The reliability model parameters are obtained by measuring the changes in the device parameter of the thin-film transistor with time.

According to the calculated variation of the device parameter, the reliability simulation system 700 changes the device parameter of the thin-film transistor in the device model parameter data 720. Then, through the circuit simulation model 730, the operation timing waveform of the circuit is re-calculated.

In the present embodiment, the circuit simulation module 730 calculates the operation timing waveform of the gate, the source and the drain of the thin-film transistor, for example. The reliability simulation module 740 takes into consideration of the operating timing waveforms of the gate, the source and the drain of the thin-film transistor, the operating time and the operating temperature to calculate the variation of the device parameter of the thin-film transistor. Hence, the device parameter of the thin-film transistor in the device model parameter data 720 are changed so that the circuit simulation module 730 can re-calculate the operation timing waveform of the circuit and add a reliability analysis to the circuit simulation.

In the following, another embodiment is provided to explain a system for simulating circuit reliability so that anyone familiar with the techniques in this area can easily apply the present invention.

FIG. 8 shows another system for simulating circuit reliability according to one embodiment of the present invention. The system is used to simulate a circuit and estimate the operation timing waveform of the circuit. The circuit includes a plurality of circuit devices. The circuit devices include at least one thin-film transistor or other type of thin-film transistor.

As shown in FIG. 8, the reliability simulation system 800 includes device model parameter data 810, a circuit netlist 820, a circuit simulation module 830 and a reliability simulation module 840. The device model parameter data 810, the circuit netlist 820, the circuit simulation module 830 and the reliability simulation module 840 are similar to the corresponding ones in FIG. 7. Hence, there is no need to repeat their descriptions.

The main difference between the reliability simulation system 800 in FIG. 8 and the reliability simulation system 700 in FIG. 7 is that the reliability simulation module 840 is coupled to the circuit netlist 820. Therefore, when the reliability simulation module 840 calculates the variation of the device parameter, the circuit structure in the circuit netlist 820 is also changed. Then, through the circuit simulation module 830, the operation timing waveform of the circuit is re-calculated.

In the present embodiment, the circuit simulation module 830 calculates the operation timing waveforms of the gate, the source and the drain of the thin-film transistor, for example. The reliability simulation module 840 takes into consideration of the operation timing waveforms of the gate, the source and the drain of the thin-film transistor, the operating time and the operating temperature to calculate the variation of the device parameter of the thin-film transistor. Then, an equivalent circuit device is added to the simulated circuit in order to equate with the variation of the device parameter of the thin-film transistor. The circuit simulation module 830 re-calculates the operation timing waveform of the circuit and adds a reliability analysis to the circuit simulation. The foregoing equivalent circuit device includes an equivalent voltage source, an equivalent resistor, an equivalent current source or an equivalent capacitor.

In summary, the present invention adds a reliability analysis of the circuit to simulate a circuit so that the circuit designer is able to estimate the operation of the circuit more realistically. Moreover, one can deduce from the foregoing embodiments that the present invention can be implemented using any conventional circuit simulation program. In other words, the method and system provided in the present invention can be written as a caller program so that any circuit designer working with a circuit simulation program can directly use the caller program to analyze circuit reliability.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for simulating circuit reliability, wherein the circuit comprises a plurality of circuit devices, and the circuit devices comprise at least one thin-film transistor, the method for simulating circuit reliability comprising:
inputting a device parameter and a circuit structure of a portion of the circuit devices;
using a reliability simulation module to calculate a variation of the device parameter of the thin-film transistor according to a reliability model parameter and a reliability influence parameter;
changing either the device parameter or the circuit structure of the thin-film transistor according to the variation; and
calculating an operation timing waveform of the circuit through a circuit simulation module.

2. The method of claim 1, further comprising calculating the operation timing waveforms of the gate, the source and the drain of the thin-film transistor through the circuit simulation module after inputting the device parameters and the circuit structure.

3. The method of claim 2, wherein the reliability influence parameter in calculating the variation comprises the operation timing waveforms of the gate, the source and the drain of the thin-film transistor.

4. The method of claim 1, wherein the reliability influence parameter comprises an operating temperature and an operating time.

5. The method of claim 1, wherein the reliability influence parameter comprises an operating time and the operation timing waveform.

6. The method of claim 1, wherein the step of changing the circuit structure of the thin-film transistor comprises:
adding an equivalent circuit device to the circuit to change the circuit structure of the thin-film transistor.

7. The method of claim 6, wherein the foregoing equivalent circuit device is used to equate with the variation of the device parameter of the thin-film transistor, and the equivalent circuit device comprises an equivalent voltage source, an equivalent resistor, an equivalent current source or an equivalent capacitor.

8. The method of claim 1, further comprising:
measuring the changes in the device parameter of the foregoing thin-film transistor with time to obtain the reliability model parameter.

9. The method of claim 1, wherein the thin-film transistor comprises an amorphous silicon thin-film transistor.

10. The method of claim 1, wherein the device parameter of the thin-film transistor comprises threshold voltage, drain current and leakage current.

11. A method for simulating circuit reliability, wherein the circuit comprises a plurality of circuit devices, and the circuit devices comprise at least one thin-film transistor, the method for simulating circuit reliability comprising:
inputting a device parameter and a circuit structure of a portion of the circuit devices;
providing a time-varying parameter circuit simulation module; and
calculating an operation timing waveform of the circuit using the time-varying parameter circuit simulation module.

12. The method of claim 11, wherein the time-varying parameter circuit simulation module is used to calculate the operation timing waveform of the foregoing circuit and a variation of the device parameter of the foregoing thin-film transistor.

13. The method of claim 12, wherein factors influencing the foregoing variation comprise an operating temperature and an operating time.

14. The method of claim 12, wherein factors influencing the foregoing variation comprise an operating time and the foregoing operation timing waveform.

15. The method of claim 11, wherein the thin-film transistor comprises an amorphous silicon thin-film transistor.

16. The method of claim 11, wherein the device parameter of the thin-film transistor comprises threshold voltage, drain current and leakage current.

17. A system for simulating circuit reliability, wherein the circuit comprises a plurality of circuit devices, and the circuit devices comprise at least one thin-film transistor, the system for simulating circuit reliability comprising:
a circuit netlist used for describing a circuit structure of the circuit;
a device model parameter data used for describing a device parameter of each of the circuit devices in the circuit;
a circuit simulation module for calculating an operation timing waveform of the circuit according to the circuit structure and the device parameters; and
a reliability simulation module for calculating a variation of the device parameter of the thin-film transistor according to a reliability model parameter and a reliability influence parameter;
wherein the reliability simulation system changes either the device parameter or the circuit structure of the thin-film transistor according to the variation, and through the circuit simulation module, re-calculates the operation timing waveform of the circuit.

18. The system of claim 17, wherein the operation timing waveform in the circuit that is calculated by the circuit simulation module comprises the operation timing waveforms of the gate, the source and the drain of the thin-film transistor, and the reliability influence parameter comprises the operation timing waveforms of the gate, the source and the drain of the thin-film transistor.

19. The system of claim 17, wherein the reliability influence parameter comprises an operating temperature and an operating time.

20. The system of claim 17, wherein the reliability influence parameter comprises an operating time and the foregoing operation timing waveform.

21. The system of claim 17, wherein the reliability simulation module adds an equivalent circuit device to the circuit to change the circuit structure of the thin-film transistor.

22. The system of claim 21, wherein the foregoing equivalent circuit device is used to equate with the variation of the device parameter of the thin-film transistor, and the equivalent circuit device comprises an equivalent voltage source, an equivalent resistor, an equivalent current source or an equivalent capacitor.

23. The system of claim 17, wherein the reliability model parameter is obtained by measuring the changes in the device parameter of the thin-film transistor with time.

24. The system of claim 17, wherein the thin-film transistor comprises an amorphous silicon thin-film transistor.

25. The system of claim 17, wherein the device parameter of the thin-film transistor comprises threshold voltage, drain current and leakage current.
